(19) United States
(12) Patent Application Publication
(10) Pub. No.: US 2023/0336411 A1
(43) Pub. Date: Oct. 19, 2023

(54) SYSTEM AND METHOD FOR IMPLEMENTATION OF NETWORK APPLICATIONS

(71) Applicant: Rakuten Symphony Singapore Pte. Ltd., Singapore (SG)

(72) Inventors: Ram METKAR, Madhya Pradesh (IN); Praveen TRIPATHI, Madhya Pradesh (IN); Shubham RATHORE, Madhya Pradesh (IN)

(21) Appl. No.: 17/723,384

(22) Filed: Apr. 18, 2022

(51) Int. Cl. H04L 41/0806; H04L 41/0895; H04L 41/22; G06F 8/60

(52) U.S. Cl. CPC H04L 41/0806; H04L 41/0895; H04L 41/22; G06F 8/60

(57) ABSTRACT

A computer-implemented method includes receiving an application manifest file from an application; mapping application manifest file parameters from the application manifest file to an IP manager; determining services available based on the mapped application manifest file parameters; and deploying the application on one or more virtual machines (VMs) or one or more containers.

### BACKGROUND

Network functions virtualization (NFV) is a network architecture concept that leverages virtualization technologies to virtualize entire classes of network node functions into building blocks that connect, or chain together, to create and deliver communication services. NFV is based upon traditional server-virtualization techniques such as those used in enterprise information technology (IT). A virtualized network function, or VNF, is implemented within one or more virtual machines (VMs) or containers running different software and processes, on top of commercial off the shelf (COTS) high-volume servers, switches, and storage devices, or even cloud computing infrastructure, instead of having custom hardware appliances for each network function. The decoupling of the network function software from the customized hardware platform realizes a flexible network architecture that enables agile network management. A Cloud-Native Network Function (CNF) is a software-implementation of a network function, which runs inside a Linux container that is traditionally performed by a physical device. CNFs are a successor to VNFs.

### BRIEF DESCRIPTION OF DRAWINGS

Aspects of the present disclosure are best understood from the following detailed description when read with the accompanying figures. In accordance with the standard practice in the industry, various features are not drawn to scale. In fact, the dimensions of the various features are arbitrarily increased or reduced for clarity of discussion.

FIG. 1A is a diagram of a network application implementation system, in accordance with one or more embodiments.

FIG. 1B is a pictorial representation of a network application implementation system, in accordance with some embodiments.

FIG. 2 is a pictorial representation of a GUI, in accordance with one or more embodiments.

FIG. 3 is a flowchart of a process for network application implementation, in accordance with one or more embodiments.

FIG. 4 is a functional block diagram of a computer or processor-based system upon which or by which some embodiments are implemented.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation or position of a first feature over or on a second feature in the description that follows include embodiments in which the first and second features are formed or positioned in direct contact and include embodiments in which additional features are formed or positioned between the first and second features, such that the first and second features are in indirect contact. In addition, the present disclosure repeats reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, are used herein for ease of description to describe one element or feature's relationship to another element(s) or feature(s) as illustrated in the figures. The spatially relative terms are intended to encompass different orientations of a system or object in use or operation in addition to the orientation depicted in the figures. The system is otherwise oriented (rotated 90 degrees or at other orientations) and the spatially relative descriptors used herein likewise are interpreted accordingly.

In some embodiments, a computer-implemented method includes receiving an application manifest file from an application; mapping application manifest file parameters from the application manifest file to an IP address management (IPAM); determining services available in an operations support system (OSS) based on the mapped application manifest file parameters; and deploying the application on one or more virtual machines (VMs) or one or more containers.

In some embodiments, the mapping the application manifest file parameters from the application manifest file to the IPAM further includes determining each static application manifest file parameter of the application manifest file of the application. In some embodiments, the mapping the application manifest file parameters from the application manifest file to the IPAM further includes determining each variable application manifest file parameter of the application manifest file of the application. In some embodiments, the method further includes, responsive to determining that an application manifest file parameter is variable, determining a value for the application manifest file parameter from the application manifest file. In some embodiments, the method further includes creating a network function descriptor (NFD) that determines instantiation parameters and operational behaviors of VNFs to execute the application. In some embodiments, the method further includes causing a graphical user interface (GUI) to be output by a display, the GUI including a network service descriptor (NSD) template that includes one or more user input fields configured to receive a user input to modify the instantiation parameters and operational behaviors to create a network service to provide the application through a VNF. In some embodiments, the method further includes creating one or more network service VMs for executing the application. In some embodiments, the creating the one or more network service VMs, further includes deploying a plurality of network service VMs automatically. In some embodiments, the creating the one or more network service VMs, further includes receiving manual service creation of the one or more network service VMs. In some embodiments, the method further includes deploying one or more VNFs to the network via the GUI through an orchestrator.

Other approaches for the deployment of applications on VMs or with containers allows for the manual deployment of applications via a cloud server. An application program (application or app for short) is a computer program or software program designed to carry out a specific task other than one relating to the operation of the computer, typically to be used by end-users. Word processors, media players, and accounting software are examples. Traditionally applications are bundled with the computer and its system software or published separately and coded as proprietary, open-source, or projects. A cloud server runs its own copy of an operating system (OS), and customers have super-user-level access to that operating system instance, so they are able to install almost any software that runs on the cloud server OS. For many purposes a cloud server is functionally equivalent to a dedicated physical server and, being software-defined, is created, and configured much more easily.

Other approaches for the deployment of applications on VMs or with containers provide platforms to create client applications using open-source orchestration tools to manage containers. Open source is source code that is made freely available for possible modification and redistribution. OS-level virtualization is an OS paradigm in which the kernel (e.g., the central component of most OSs) allows the existence of multiple isolated user space instances (e.g., VMs). Such instances, called containers, zones, virtual private servers, partitions, virtual environments, virtual kernels, or jails (referred to containers hereinafter), look like real computers from the point of view of programs running in them. A computer program running on an ordinary operating system sees all resources (connected devices, files and folders, network shares, CPU power, quantifiable hardware capabilities) of that computer. However, programs running inside of a container see the container's contents and devices assigned to the container. Containers are only megabytes in size, take just seconds to start, and more portable than VMs, versus gigabytes and minutes for a VM. VMs and containers differ in several ways, but containers provide a way to virtualize an OS so that multiple workloads are able to run on a single OS instance. With VMs, the hardware is being virtualized to run multiple OS instances.

There are other approaches that allow for the deployment of applications via a cloud server and platforms to create client applications using open-source orchestration tools to manage containers, however, these approaches are limited in that all the parameters of an application (e.g., within an application manifest file) are entered manually by an administrator or operator before a VM or container is created. This is a labor-intensive process as the administrator or operator must locate the parameter of the application within the application manifest file, then transfer the parameter to an NSD, and then repeat this process for each parameter within the NSD.

An application manifest file in computing is a file containing metadata for a group of accompanying files that are part of a set or coherent unit. For example, the files of a computer program have a manifest describing the name, version number, license, and the constituent files of the program. The term is borrowed from a cargo shipping procedure, where a ship manifest would list the crew and/or cargo of a vessel. Linux distributions rely on package management systems for distributing software. In this scheme, a package is an archive file (used to collect multiple data files together into a single file for easier portability and storage, or simply to compress files to use less storage space) containing an application manifest file. The purpose is to enumerate the files which are included in the distribution, either for processing by various packaging tools or for human consumption. A CNF includes multiple roles and multiple environment parameters. The application manifest file comprises a description of these multiple roles and multiple environment parameters. Thus, in some embodiments, a network application implementation system and method use this information from this application manifest file to automatically create the application by mapping parameters from an application manifest file to an NSD.

In some embodiments, a network application implementation system and method are configured to use a NSD user interface (UI) (e.g., a blueprint of CNF details) to automatically onboard (e.g., deploy/create) an application (e.g., through a VM or container). The behavior of the NFV orchestrator (NFVO) and virtualized network function manager (VNFM) is driven by the contents of deployment templates (a.k.a., NFV descriptors) such as a NSD and a VNF Descriptor (VNFD). The VNFD file describes the instantiation parameters and operational behaviors of the VNFs. The VNFD file contains KPIs, and other key requirements that are used in the process of onboarding and managing the lifecycle of a VNF. The VNF deployment data model is an XML file or template describing the resource requirements, networking, day zero configuration, and other service operational behaviors such as monitoring KPI, placement policies, lifecycle stages, scaling rules and the like.

An NSD is a deployment template that describes a network service's deployment and operational requirement. An NSD is configured to be used to create a network service where life-cycle management operations are performed. Deployment templates are discussed in detail in ETSI GS NFV-IFA 014: “Network Functions Virtualization (NFV) Release 3; Management and Orchestration; Network Service Templates Specification”, herein incorporated by reference in entirety. In some embodiments, the same NSD UI configured for radio-access networks (RAN) and core network (CN) application deployments is configured to be used for the automatic deployment of VMs and containers.

In some embodiments, a network application implementation system automatically generates a network service template (e.g., a NSD or a VNFD) and maps parameters from an application manifest file into the network service template. In some embodiments, parameters from the application manifest file include: (1) host name; (2) internet protocol (IP) address for the CNF IP pools, (3) domain name system (DNS) and Domain, (4) security, (5) username and password, (6) dynamic environment parameters. An environment variable is a dynamic-named value that affects the way running processes behave on a computer. Environment variables are part of the environment in which a process runs.

In some embodiments, a network application implementation system is implemented on a radio access network (RAN) and CN. A backbone or CN is a part of a computer network which interconnects networks, providing a path for the exchange of information between different LANs or subnetworks. A RAN is part of a mobile telecommunication system. A RAN implements a radio access technology and resides between devices such as a mobile phone, a computer, or any remotely controlled machine and provides connection with the CN.

In some embodiments, applications are created for virtualization and implemented in a control plane, data plane, user plane or any other suitable environment for making a virtualized network. In network routing, the control plane is the part of the router architecture that is concerned with drawing the network topology, or the information in a routing table that defines what to do with incoming packets. In computing, the control plane is the part of the software that configures and shuts down the data plane. By contrast, the data plane is the part of the software that processes the data requests. The data plane is also sometimes referred to as the forwarding plane. The data plane is optimized for speed of processing, and for simplicity and regularity. The control plane is optimized for customizability, handling policies, handling exceptional situations, and in general facilitating and simplifying the data plane processing. In routing, the forwarding plane, sometimes called the data plane or user plane, defines the part of the router architecture that decides what to do with packets arriving on an inbound interface. Most commonly, it refers to a table in which the router looks up the destination address of the incoming packet and retrieves the information necessary to determine the path from the receiving element, through the internal forwarding fabric of the router, and to the proper outgoing interface(s).

In some embodiments, a network application implementation system receives an application manifest file from an application owner. In some embodiments, the network application implementation automatically uploads the application manifest file to a graphic user interface (GUI). In some embodiments, the network application implementation system generates a network service template and maps the application manifest file parameters to internet protocol address management (IPAM) naming security inventory.

In some embodiments, the application owner decides which parameters of the application manifest file are static and which are variable. In computer programming, a static variable is a variable that has been allocated statically, meaning that its lifetime (or extent) is the entire run of the program. This contrasts with shorter-lived automatic variables, whose storage is stack allocated and deallocated on the call stack; and in contrast to objects, whose storage is dynamically allocated and deallocated in heap memory. In some embodiments, an application owner indicates which parameter is variable, and the network application implementation system automatically detects the values of these variable parameters from the application manifest file.

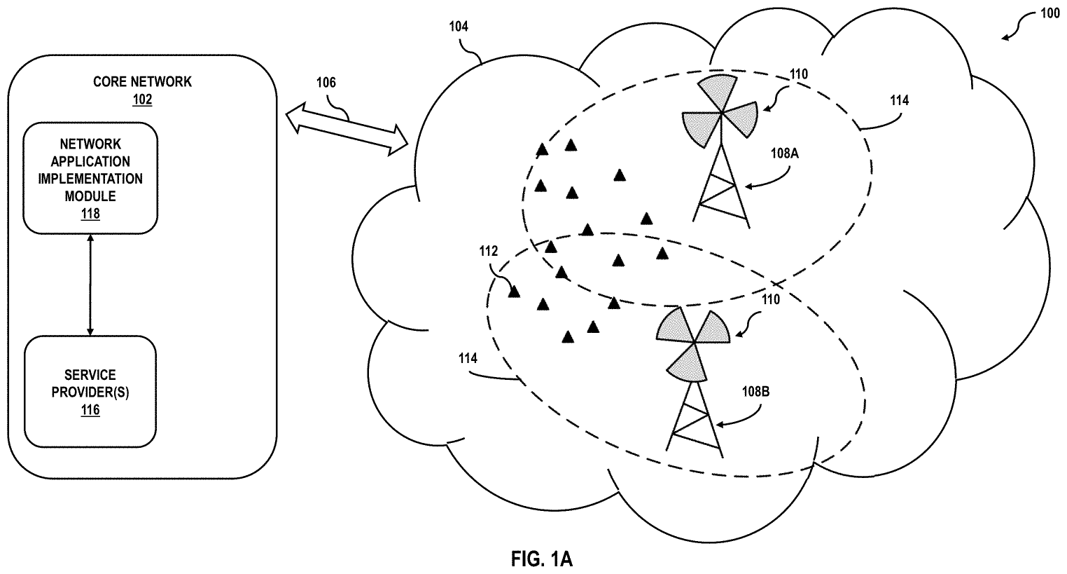

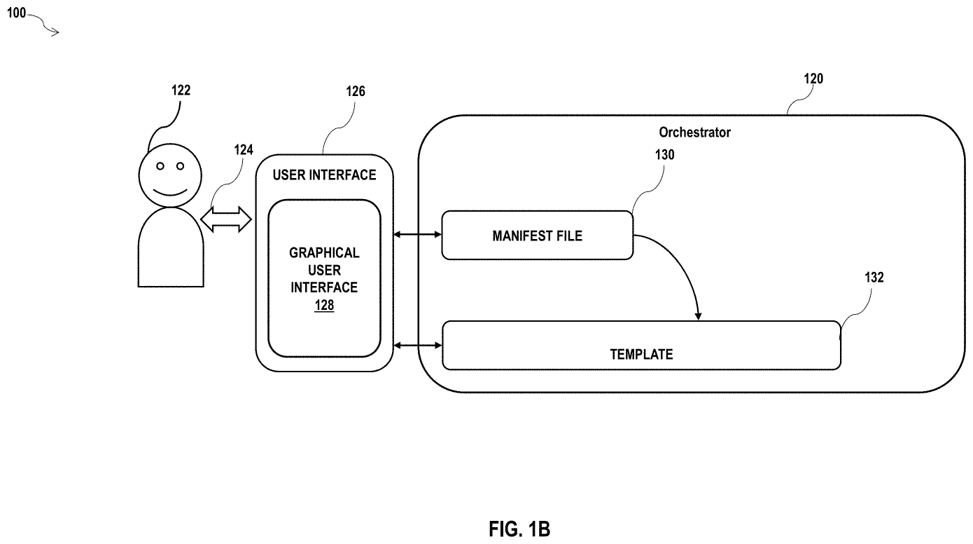

FIG. 1A is a diagram of a network application implementation (NAI) system 100, in accordance with one or more embodiments.

NAI system 100 includes a CN 102 communicatively connected to RAN 104 through backhaul 106, which is communicatively connected to base stations 108A and 108B (hereinafter base station 108), with antennas 110 that are wirelessly connected to UEs 112 located in geographic coverage areas 114. CN 102 includes one or more service provider(s) 116 and a NAI module 118.

CN 102 (also known as a backbone) is a part of a computer network which interconnects networks, providing a path for the exchange of information between different local area networks (LANs) or subnetworks. In some embodiments, CN 102 ties together diverse networks in the same building, in different buildings in a campus environment, or over wide geographic areas.

In some embodiments, RAN 104 is a global system for mobile communications (GSM) RAN, a GSM/EDGE RAN, a universal mobile telecommunications system (UMTS) RAN (UTRAN), an evolved universal terrestrial radio access network (E-UTRAN, open RAN (O-RAN), or cloud-RAN (C-RAN). RAN 104 resides between user equipment 112 (e.g., mobile phone, a computer, or any remotely controlled machine) and CN 102.

In a hierarchical telecommunications network, backhaul portion 106 of NAI 100 comprises the intermediate link(s) between CN 102 and RAN 104. The two main methods of mobile backhaul implementations are fiber-based backhaul and wireless point-to-point backhaul. Other methods, such as copper-based wireline, satellite communications and point-to-multipoint wireless technologies are being phased out as capacity and latency requirements become higher in 4G and 5G networks. Backhaul generally refers to the side of the network that communicates with the global Internet. UE 112 communicating with a base station 108 constitute a local subnetwork. The connection between base station 108 and UE 112 begins with backhaul 106 connected to CN 102. In some embodiments, backhaul 106 includes wired, fiber optic and wireless components. Wireless sections include using microwave bands and mesh and edge network topologies that use a high-capacity wireless channel to get packets to the microwave or fiber links.

In some embodiments, base stations 108 are lattice or self-supported towers, guyed towers, monopole towers, and concealed towers (e.g., towers designed to resemble trees, cacti, water towers, signs, light standards, and other types of structures). In some embodiments, base stations 108 are a cellular-enabled mobile device site where antennas and electronic communications equipment are placed, typically on a radio mast, tower, or other raised structure to create a cell (or adjacent cells) in a network. The raised structure typically supports antenna(s) 110 and one or more sets of transmitter/receivers, transceivers, digital signal processors, control electronics, a remote radio head (RRH), primary and backup electrical power sources, and sheltering. Base stations are known by other names such as base transceiver station, mobile phone mast, or cell tower. In some embodiments, base stations are edge devices configured to wirelessly communicate with UEs. The edge device provides an entry point into service provider CNs, such as CN 102. Examples include routers, routing switches, integrated access devices (IADs), multiplexers, and a variety of metropolitan area network (MAN) and wide area network (WAN) access devices.

In at least one embodiment, antenna(s) 110 are a sector antenna. In some embodiments, antenna(s) 110 are a type of directional microwave antenna with a sector-shaped radiation pattern. In some embodiments, the sector degrees of arc are 60°, 90° or 120° designs with a few degrees extra to ensure overlap. Further, sector antennas are mounted in multiples when wider coverage or a full-circle coverage is desired. In some embodiments, antenna(s) 110 are a rectangular antenna, sometimes called a panel antenna or radio antenna, used to transmit and receive waves or data between mobile devices or other devices and a base station. In some embodiments, antenna(s) 110 are circular antennas. In some embodiments, antenna 110 operates at microwave or ultra-high frequency (UHF) frequencies (300 MHz to 3 GHz). In other examples, antenna(s) 110 are chosen for their size and directional properties.

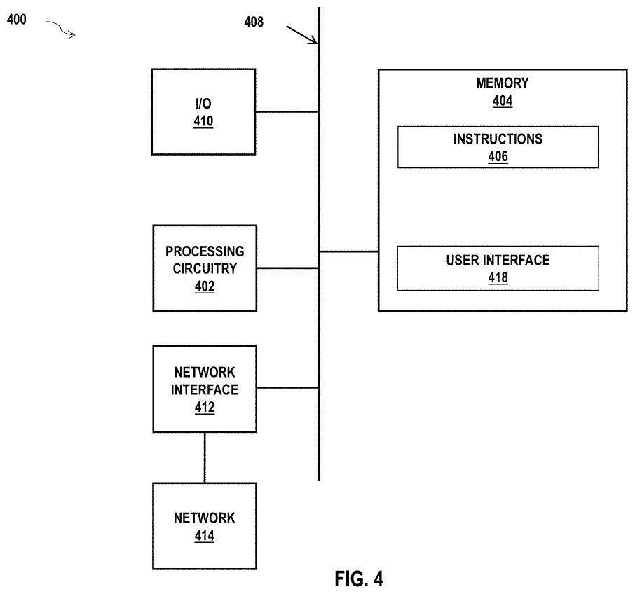

In some embodiments, UEs 112 are a computer or computing system. Additionally, or alternatively, UEs 112 have a liquid crystal display (LCD), light-emitting diode (LED) or organic light-emitting diode (OLED) screen interface, such as graphical user interface 128 (FIG. 1B) and user interface (UI) 418 (FIG. 4), providing a touchscreen interface with digital buttons and keyboard or physical buttons along with a physical keyboard. In some embodiments, UE 112 connects to the Internet and interconnects with other devices. Additionally, or alternatively, UE 112 incorporates integrated cameras, the ability to place and receive voice and video telephone calls, video games, and Global Positioning System (GPS) capabilities. Additionally, or alternatively, UEs perform as a virtual machine or allow third-party apps to run as a container. In some embodiments, UEs 112 are a computer (such as a tablet computer, netbook, digital media player, digital assistant, graphing calculator, handheld game console, handheld personal computer (PC), laptop, mobile internet device (MID), personal digital assistant (PDA), pocket calculator, portable medial player, or ultra-mobile PC), a mobile phone (such as a camera phone, feature phone, smartphone, or phablet), a digital camera (such as a digital camcorder, or digital still camera (DSC), digital video camera (DVC), or front-facing camera), a pager, a personal navigation device (PND), a wearable computer (such as a calculator watch, smartwatch, head-mounted display, earphones, or biometric device), or a smart card.

In at least one embodiment, geographic coverage areas 114 are most any shape and size. In some embodiments, geographic coverage areas 114 are a macro-cell (covering 1 Km-30 Km), a micro-cell (covering 200m-2 Km), or a pico-cell (covering 4 m-200 m). In some embodiments, geographic coverage areas are circular, oval or sector in shape, but geographic coverage areas 114 are configured in most any shape or size. Geographic coverage areas 114 represent the geographic area where antenna 110 and UEs 112 are configured to communicate.

Service provider(s) 116 are businesses or organizations that sell bandwidth or network access by providing direct Internet backbone access to internet service providers and usually access to its network access points (NAPs). Service providers are sometimes referred to as backbone providers or internet providers. Service providers consist of telecommunications companies, data carriers, wireless communications providers, Internet service providers, and cable television operators offering high-speed Internet access.

In some embodiments, an NAI system 100, includes processing circuitry, like processing circuitry 402 (FIG. 4); and a memory, such as memory 404 (FIG. 4) having instructions, such as NAI module 118, stored thereon that, when executed by the processor, cause the NAI system 100 to receive an application manifest file from an application, map the application manifest file parameters from the application manifest file to an IP address management (IPAM) software, determine services available in an operations support system (OSS) based on the mapped application manifest file parameters, and deploy the application to the CN and RAN.

In some embodiments, NAI module 118 determines each static application manifest file parameter of the application manifest file of the application. In some embodiments, NAI module 118 determines each variable application manifest file parameter of the application manifest file of the application. In some embodiments, NAI module 118, responsive to determining that an application manifest file parameter is variable, determines a value for the application manifest file parameter from the application manifest file. In some embodiments, NAI module 118 creates a NFD that determines instantiation parameters and operational behaviors of virtual network functions (VNFs) to execute the application. In some embodiments, NAI system 100 further includes a GUI to be output by a display, the GUI including a NSD template that includes one or more user input fields configured to receive a user input to modify the instantiation parameters and operational behaviors to create a network service to provide the application through a VNF.

FIG. 1B is a pictorial representation of a network application implementation system 100, in accordance with some embodiments.

NAI 100 system includes user interface (U/I) 126. NAI system 100 includes processing circuitry 402 (FIG. 4) and includes a memory 404 (FIG. 4) connected to processing circuitry 402 (FIG. 4), where the memory is configured to store executable instructions 406 (FIG. 4). Executable instructions 406 when executed by processing circuitry 402, facilitate performance of operations, including receiving, from a user 122, a new input request 124, at user interface 126, including identification of static and variable parameters. User interface 126 allows user 122 to input which of the parameters are variable. Orchestrator 120 uploads an application manifest file 130 of an application into GUI 128 representing a network service template 132. Orchestrator 120 maps the parameters from application manifest file 130 to IPAM software naming security inventory (e.g., services available in OSS).

In some embodiments, user 122 is a person who utilizes a computer or network service, such as CN 102 or RAN 104. A user often has a user account and is identified to the system by a username (or username). Other terms for username include login name, screenname (or screen name), account name, nickname (or nick). End users are the ultimate human users (also referred to as operators) of a software product. The end user stands in contrast to users who support or maintain the product such as sysops (system operations), database administrators and computer technicians.

In some embodiments, user interface (UI) 126 is the space where interactions between humans and machines occur. In some embodiments, UI 126 is located at or a part of a UE, such as UEs 112. The goal of interactions between humans and machines is to allow effective operation and control of the machine from the user end, while the machine simultaneously feeds back information that aids the operators' decision-making process. Generally, the goal of UI design is to produce a UI which is easy, efficient, and enjoyable (user-friendly) to operate a machine in the way which produces the desired result (i.e., maximum usability). This generally means that the operator needs to provide minimal input to achieve the desired output, and that the machine minimizes undesired outputs to the user. User interfaces are composed of one or more layers, including a human—machine interface (HMI) that interfaces machines with physical input hardware such as keyboards, mice, or game pads, and output hardware such as computer monitors, speakers, and printers. A device that implements an HMI is called a human interface device (HID). Other terms for human—machine interfaces are man—machine interface (MMI) and, when the machine in question is a computer, human—computer interface. Additional UI layers may interact with one or more human senses, including: tactile UI (touch), visual UI (sight), auditory UI (sound), olfactory UI (smell), equilibrial UI (balance), and gustatory UI (taste).

Composite user interfaces (CUIs) are UIs that interact with two or more senses. The most common CUI is a GUI, such as GUI 128, which is composed of a tactile UI and a visual UI capable of displaying graphics. When sound is added to a GUI, it becomes a multimedia user interface (MUI). There are three broad categories of CUI: standard, virtual, and augmented. Standard CUI use standard human interface devices like keyboards, mice, and computer monitors. When the CUI blocks out the real world to create a virtual reality, the CUI is virtual and uses a virtual reality interface. When the CUI does not block out the real world and creates augmented reality, the CUI is augmented and uses an augmented reality interface. When a UI interacts with all human senses, it is called a qualia interface, named after the theory of qualia. CUI is classified by how many senses they interact with as either an X-sense virtual reality interface or X-sense augmented reality interface, where X is the number of senses interfaced with.

Orchestrator 120 is the automated configuration, coordination, and management of computer systems and software. Orchestration is often discussed in the context of service-oriented architecture, virtualization, provisioning, converged infrastructure, and dynamic datacenter topics. Orchestration in this sense is about aligning the business request with the applications, data, and infrastructure. In the context of cloud computing, the main difference between workflow automation and orchestration is that workflows are processed and completed as processes within a single domain for automation purposes, whereas orchestration includes a workflow and provides a directed action towards larger goals and objectives. In this context, and with the overall aim to achieve specific goals and objectives (described through quality-of-service parameters), for example, meet application performance goals using minimized cost and maximize application performance within budget constraints, cloud management solutions also encompass frameworks for workflow mapping and management.

Application manifest file 130 is a file containing metadata for a group of accompanying files that are part of a set or coherent unit. For example, the files of a computer program have a manifest describing the name, version number, license, and the constituent files of the program. Linux distributions rely on package management systems for distributing software. In this scheme, a package is an archive file containing an application manifest file. The purpose is to enumerate the files which are included in the distribution, either for processing by various packaging tools or for human consumption. Manifests contain additional information and specify a version number and an entry point for execution.

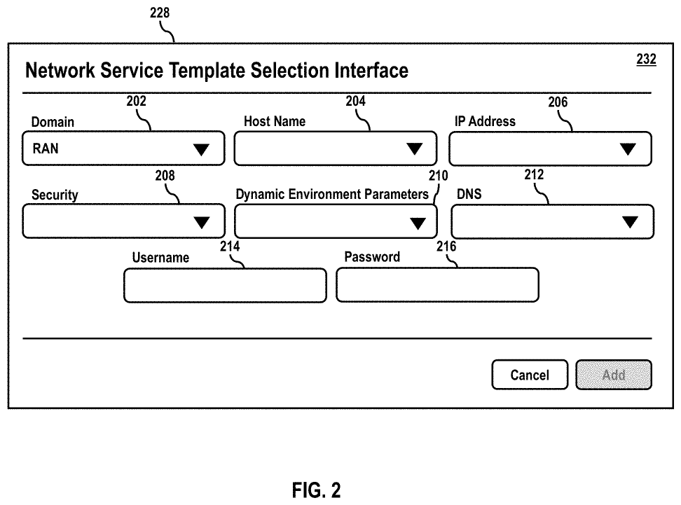

In some embodiments, template 132 is a form-fill interface that consists of onscreen forms or Web-based forms displaying fields containing data items or parameters that need to be communicated to the user or received from the user, such as user 122. The template often is a facsimile of a paper form already familiar to the user. This interface technique is also known as a form-based method and input/output forms. FIG. 2 shows a template or form-fill interface. Forms for display screens, such as GUI 128 are set up to show what information is requested for input and where. Blank fields requiring information are capable of being highlighted with inverse or flashing characters. The cursor is moved by user 122 from field to field by a single stroke of an arrow key. This arrangement allows movement one field backward or one field forward by clicking the appropriate arrow key. This arrangement provides user 122 good control over data entry. Web-based forms afford the opportunity to include hyperlinks to examples of correctly filled-out forms or to further help and provide examples. Form input for displays is capable of being simplified by supplying default values for fields and then allowing users to modify default information if necessary. Input for display screen fields is capable of being alphanumerically restricted so that, for example, users enter only numbers in a field requesting a Social Security number, or they input only letters where a person's name is required. If numbers are input where only letters are allowed, an alert occurs notifying the user via audio output that the field was filled out incorrectly. Template 132 shows field labels as well as the context for entries. In addition, Web forms return incomplete forms to the user with an explanation of what data must be entered to complete the transaction. Often, fields with missing data are marked with a red asterisk. In some embodiments, template 132 is a template such as a NSD and a VNF Descriptor (VNFD).

In some embodiments, an application owner, such as user 122, decides which parameters within the application manifest file are static and which are variable. In some embodiments, the application owner indicates which parameter is variable, and orchestrator 120 automatically detects the values of these variable parameters from the application manifest file.

A part of controlling the NFV environment is done through automated orchestration, such as orchestrator 120. NFV Management and Orchestration (NFV-MANO) refers to a set of functions within an NFV system to manage and orchestrate the allocation of virtual infrastructure resources to virtualized network functions (VNFs) and network services (NSs). NFV-MANO are the brains of the NFV system and a key automation enabler.

The main functional blocks within the NFV-MANO architectural framework (ETSI GS NFV-006) are: (1) Network Functions Virtualization Orchestrator (NFVO); (2) Virtualized Network Function Manager (VNFM); Virtualized Infrastructure Manager (VIM).

The entry point in NFV-MANO for external operations support systems (OSS) and business support systems (BSS) is the NFVO, which oversees managing the lifecycle of NS instances. The management of the lifecycle of VNF instances constituting an NS instance is delegated by the NFVO to one more or VNFMs. Both the NFVO and the VNFMs uses the services exposed by one or more VIMs for allocating virtual infrastructure resources to the objects they manage. Additional functions are used for managing containerized VNFs: the Container Infrastructure Service Management (CISM) and the Container Image Registry (CIR) functions. The CISM is responsible for maintaining the containerized workloads while the CIR is responsible for storing and maintaining information of OS container software images The behavior of the NFVO and VNFM is driven by the contents of deployment templates (a.k.a. NFV descriptors) such as a Network Service Descriptor (NSD) and a VNF Descriptor (VNFD).

A full set of standards enable an open ecosystem where Virtualized Network Functions (VNFs) are interoperable with independently developed management and orchestration systems, and where the components of a management and orchestration system are themselves interoperable. This includes a set of restful application programming interface (API) specifications as well as the specifications of a packaging format for delivering VNFs to service providers and of the deployment templates to be packaged with the software images to enable managing the lifecycle of VNFs. Deployment templates can be based on topology and orchestration specification for cloud applications (TOSCA) or yet another next generation (YANG).

An OpenAPI (a.k.a. Swagger) representation of the API specifications is available and maintained on a forge server, along with TOSCA and YANG definition files to be used when creating deployment templates.

In some embodiments, orchestrator 120 creates an NFD. A NFD is a deployment template that describes a network function deployment and operational requirement. NFD is used to create a network function where life-cycle management operations are performed. In some embodiments, orchestrator 120 creates a NSD template. In the context of the NFV framework, a new Network Service is on-boarded and instantiated into the system using an NSD. The NSD is essentially a collection of configuration documents, determining exactly how the Network Service is comprised in terms of required VNFs and their associated VNFFGD (VNF Forwarding Graph Descriptor).

In some embodiments, orchestrator 120 maps parameters within the application manifest file with an IPAM manager, naming manager, security manager, and inventory. An IPAM manager manages the administration of domain name system (DNS) and dynamic host configuration protocol (DHCP), which are the network services that assign and resolve IP addresses to machines in a TCP/IP network. IPAM is a means of planning, tracking, and managing the IP address space used in a network. Tools such as DNS and DHCP are used in tandem to perform this task, though true IPAM will combine these services together so that each is aware of changes in the other (for instance DNS knowing of the IP address taken by a client via DHCP and updating itself accordingly).

In some embodiments, a name manager is a dialog box in that allows user 122 to create, edit, and delete defined names. These names are named ranges, named formulas, and named constants. A security manager protects a computer network by maintaining secure passwords for users.

FIG. 2 is a pictorial representation of a GUI 228, in accordance with one or more embodiments.

Network application implementation module 120 is configured to cause GUI 228 to be output to a user interface 126 (FIG. 1B) for generating implementation of an application, on a network, through VMs or a container. GUI 228 is a form of UI, such as UI 418, that allows users to interact with electronic devices through graphical icons and audio indicators such as primary notation, instead of text-based user interfaces, typed command labels or text navigation. The actions in a GUI are usually performed through direct manipulation of the graphical elements. GUI 228 is used in any handheld mobile devices, such as UE 112, MP3 players, portable media players, gaming devices, smartphones and smaller household, office and industrial controls, and the like.

GUI 228 includes a domain field 202 configured to receive an input identifying a target domain for a desired application. A user is able to select from a RAN, a wide area network (WAN), a metropolitan area network (MAN), an internet area network (IAN), a telecommunications network, or the like.

GUI 228 includes a host name field 204 configured to receive a user input identifying a host. A host is a computer or other device connected to a computer network. A host may work as a server offering information resources, services, and applications to users or other hosts on the network. Hosts are assigned at least one network address. A computer participating in networks that use the Internet protocol suite may also be called an IP host. Specifically, computers participating in the Internet are called Internet hosts. Internet hosts and other IP hosts have one or more IP addresses assigned to their network interfaces. The addresses are configured either manually by an administrator, automatically at startup by means of the Dynamic Host Configuration Protocol (DHCP), or by stateless address autoconfiguration methods.

Network hosts that participate in applications that use the client—server model of computing, are classified as server or client systems. Network hosts may also function as nodes in peer-to-peer applications, in which all nodes share and consume resources in an equipotent manner.

GUI 228 includes an IP address field 206 configured to receive a user input identifying an IP address. An IP address is a numerical label such as 192.0.2.1 that is connected to a computer network that uses the Internet Protocol for communication. An IP address serves two main functions: network interface identification and location addressing. Network administrators assign an IP address to each device connected to a network. Such assignments may be on a static (fixed or permanent) or dynamic basis, depending on network practices and software features.

GUI 228 includes a security field 208 configured to receive an input identifying security within the domain.

GUI 228 includes a dynamic environment input field 210 configured to receive an input identifying dynamic environment parameters. Dynamic environment variables (also named internal variables or system information variables) are pseudo-environment variables.

GUI 228 includes a DNS input field 212 configured to receive an input identifying a domain name. The DNS is the hierarchical and decentralized naming system used to identify computers, services, and other resources reachable through the Internet or other Internet Protocol (IP) networks. The resource records contained in the DNS associate domain names with other forms of information. These are most used to map human-friendly domain names to the numerical IP addresses computers need to locate services and devices using the underlying network protocols but have been extended over time to perform many other functions as well.

GUI 228 includes a username input field 214 and a password input field 216 configured to receive a user input for username and password. The username input field 214 and the password input field 216 are used to verify a user, such as user 122, attempting to implement an application on a network, such as RAN 104 or core 102

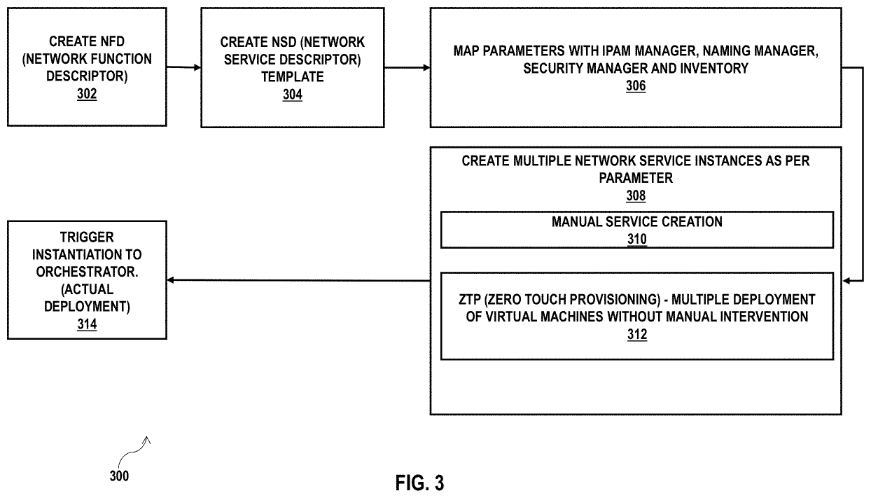

FIG. 3 is a flowchart of a process for network application implementation 300, in accordance with one or more embodiments.

In some embodiments, the network application implementation module 120 (FIG. 1A) performs the process 300 and is implemented in or by, for instance, a chip set including processing circuitry 402 and a memory 404 as shown in FIG. 4. Process 300 contains operations 302-314 that are shown and discussed being performed in sequence. However, in some embodiments, operations 302-314 are preformed out of sequential order and unless specifically stated, operations 302-314 are performed in any realistic fashion.

In operation 302, an orchestrator, such as orchestrator 120 (FIG. 1B) creates a network function descriptor (NFD). In some embodiments, network application implementation module 118 creates a NFD that determines instantiation parameters and operational behaviors of VNFs to execute an application. In some embodiments, the application is an application the user desires to place on network 104 or 102 and execute on virtual machines or containers through the network. In some embodiments, the NFD contains KPIs and other parameters that are used in the process of onboarding and managing the lifecycle of a VNF. A discussion of NFDs is found at ETSI GS NFV-SOL 001 V3.3.1, herein incorporated by reference in entirety. Process flows from operation 302 to operation 304.

In operation 304, an orchestrator, such as orchestrator 120 (FIG. 1B) creates a network service descriptor (NSD) template. In some embodiments, network application implementation module 118 (FIG. 1A) causes a graphical user interface (GUI), like GUI 128, to be output by a display, the GUI including a network service descriptor (NSD) template, like template 232, that includes one or more user input fields configured to receive a user input to modify the instantiation parameters and operational behaviors to create a network service to provide the application through a VNF. Process flows from operation 304 to operation 306.

In operation 306, an orchestrator, such as orchestrator 120 (FIG. 1B) maps parameters from an application manifest file to an IPAM manager, a security manager, and inventory. In some embodiments, network application implementation module 118 (FIG. 1A) maps IP addresses for computers, UEs, servers, or the like that will host the application as well as designated for virtual machines or able to execute containers for an application. Process flows from operation 306 to operation 308.

In operation 306, an orchestrator, such as orchestrator 120 (FIG. 1B) creates multiple network service instances of virtual machines configured to execute the application as designated in a parameter within the NSD template. The changing or modifying of the parameter to determine network service instances of virtual machines is configured to be performed manually as in operation 310 or automatically with zero-touch provisioning (ZTP) in operation 312. In some embodiments, the method further includes creating one or more network service VMs for executing the application. In some embodiments, the creating the one or more network service VMs, further includes deploying a plurality of network service VMs automatically. In some embodiments, the creating the one or more network service VMs, further includes receiving manual service creation of the one or more network service VMs. Process flows from operation 308 to operation 314.

At operation 314, network application implementation module 118 triggers instantiation to the orchestrator for deployment of the virtual machines or containers. In some embodiments, the method further includes deploying one or more VNFs to the network via the GUI through an orchestrator.

FIG. 4 is a functional block diagram of a computer or processor-based system 400 upon which or by which an embodiment is implemented.

Processor-based system 400 is programmed to facilitate network application implementation, as described herein, and includes, for example, bus 408, processing circuitry 402, and memory 404 components.

In some embodiments, the processor-based system is implemented as a single “system on a chip.” Processor-based system 400, or a portion thereof, constitutes a mechanism for performing one or more steps of facilitating network application implementation.

In some embodiments, the processor-based system 400 includes a communication mechanism such as bus 408 for transferring information and/or instructions among the components of the processor-based system 400. Processing circuitry 402 is connected to the bus 408 to obtain instructions for execution and process information stored in, for example, the memory 404. In some embodiments, the processing circuitry 402 is also accompanied with one or more specialized components to perform certain processing functions and tasks such as one or more digital signal processors (DSP), or one or more application-specific integrated circuits (ASIC). A DSP typically is configured to process real-world signals (e.g., sound) in real time independently of the processing circuitry 402. Similarly, an ASIC is configurable to perform specialized functions not easily performed by a more general-purpose processor. Other specialized components to aid in performing the functions described herein optionally include one or more field programmable gate arrays (FPGA), one or more controllers, or one or more other special-purpose computer chips.

In one or more embodiments, the processing circuitry (or multiple processors) 402 performs a set of operations on information as specified by a set of instructions stored in memory 404 related to network application implementation. The execution of the instructions causes the processor to perform specified functions.

The processing circuitry 402 and accompanying components are connected to the memory 404 via the bus 408. The memory 404 includes one or more of dynamic memory (e.g., RAM, magnetic disk, writable optical disk, or the like) and static memory (e.g., ROM, CD-ROM, or the like) for storing executable instructions that when executed perform the steps described herein to facilitate network application implementation. The memory 404 also stores the data associated with or generated by the execution of the steps.

In one or more embodiments, the memory 404, such as a random-access memory (RAM) or any other dynamic storage device, stores information including processor instructions for facilitating network application implementation. Dynamic memory allows information stored therein to be changed. RAM allows a unit of information stored at a location called a memory address to be stored and retrieved independently of information at neighboring addresses. The memory 404 is also used by the processing circuitry 402 to store temporary values during execution of processor instructions. In various embodiments, the memory 404 is a read only memory (ROM) or any other static storage device coupled to the bus 408 for storing static information, including instructions, that is not capable of being changed by processing circuitry 402. Some memory is composed of volatile storage that loses the information stored thereon when power is lost. In some embodiments, the memory 404 is a non-volatile (persistent) storage device, such as a magnetic disk, optical disk, or flash card, for storing information, including instructions, that persists even when the system 400 is turned off or otherwise loses power.

The term “computer-readable medium” as used herein refers to any medium that participates in providing information to processing circuitry 402, including instructions 406 for execution. Such a medium takes many forms, including, but not limited to computer-readable storage medium (e.g., non-volatile media, volatile media). Non-volatile media includes, for example, optical or magnetic disks. Volatile media include, for example, dynamic memory. Common forms of computer-readable media include, for example, a floppy disk, a flexible disk, a hard disk, a magnetic tape, another magnetic medium, a CD-ROM, CDRW, DVD, another optical medium, punch cards, paper tape, optical mark sheets, another physical medium with patterns of holes or other optically recognizable indicia, a RAM, a PROM, an EPROM, a FLASH-EPROM, an EEPROM, a flash memory, another memory chip or cartridge, or another medium from which a computer reads. The term computer-readable storage medium is used herein to refer to a computer-readable medium.

In some embodiments, a system includes a processor and a memory having instructions stored thereon that, when executed by the processor, cause a GUI, such as GUI 128 or 228, to be output by UI 418. UI 418 is an output device for presentation of information in visual or tactile form (the latter used for example in tactile electronic displays for blind people). When the input information that is supplied has an electrical signal the display is called an electronic display

UI 407 allows effective operation and control of system 400 by a user. In some embodiments, user interfaces are composed of one or more layers, including a human-machine interface (HMI) that interfaces machines with physical input hardware such as keyboards, mice, or game pads, and output hardware such as computer monitors, speakers, printers, and other suitable user interfaces are within the contemplated scope of the disclosure. Additional user interface layers interact with one or more human senses, including: tactile user interface (touch), visual user interface (sight), auditory user interface (sound), olfactory user interface (smell), equilibrial user interface (balance), gustatory user interface (taste) and other suitable user interface layers are within the contemplated scope of the disclosure.

In some embodiments, a computer-implemented method includes receiving an application manifest file from an application; mapping application manifest file parameters from the application manifest file to an IP manager; determining services available based on the mapped application manifest file parameters; and deploying the application on one or more virtual machines (VMs) or one or more containers.

In some embodiments, the mapping the application manifest file parameters from the application manifest file to the IP manager further includes determining each static file parameter of the application manifest file of the application set for a lifetime of the application.

In some embodiments, the mapping the application manifest file parameters from the application manifest file to the IP manager further includes determining each variable file parameter of the application manifest file of the application that is configured to be modified.

In some embodiments, the method further includes, responsive to determining that an application manifest file parameter is variable, determining a value for the application manifest file parameter from the application manifest file.

In some embodiments, the method further includes creating a network function descriptor (NFD) that determines instantiation parameters and operational behaviors of virtual network functions (VNFs) to execute the application.

In some embodiments, the method further includes causing a graphical user interface (GUI) to be output by a display, the GUI including a network service descriptor (NSD) template that includes one or more user input fields configured to receive a user input to modify the instantiation parameters and operational behaviors to create a network service to provide the application through a VNF.

In some embodiments, the method further includes creating one or more network service VMs for executing the application.

In some embodiments, the creating the one or more network service VMs, further includes deploying a plurality of network service VMs automatically.

In some embodiments, the creating the one or more network service VMs, further includes receiving manual service creation of the one or more network service VMs.

In some embodiments, the method further includes deploying one or more VNFs to the network via the GUI through an orchestrator.

In some embodiments, an apparatus, includes a processor; and a memory having instructions stored thereon that, when executed by the processor, cause the apparatus to receive an application manifest file from an application; map application manifest file parameters from the application manifest file to an IP manager; determine services available based on the mapped application manifest file parameters; and deploy the application.

In some embodiments, the instructions further cause the apparatus to determine each static file parameter of the application manifest file of the application set for a lifetime of the application.

In some embodiments, the instructions further cause the apparatus to determine each variable file parameter of the application manifest file of the application that is configured to be modified.

In some embodiments, the instructions further cause the apparatus to responsive to determining that an application manifest file parameter is variable, determine a value for the application manifest file parameter from the application manifest file.

In some embodiments, the instructions further cause the apparatus to create a network function descriptor (NFD) that determines instantiation parameters and operational behaviors of virtual network functions (VNFs) to execute the application.

In some embodiments, the apparatus further includes a graphical user interface (GUI) to be output by a display, the GUI including a network service descriptor (NSD) template that includes one or more user input fields configured to receive a user input to modify the instantiation parameters and operational behaviors to create a network service to provide the application through a VNF.

In some embodiments, a non-transitory computer readable medium having instructions stored thereon that, when executed by a processor, cause an apparatus to receive an application manifest file from an application; map application manifest file parameters from the application manifest file to an IP manager; determine services available based on the mapped application manifest file parameters; and deploy the application.

In some embodiments, the instructions further cause the processor to create one or more network service VMs for executing the application.

In some embodiments, the instructions further cause the processor to deploy a plurality of network service VMs automatically.

In some embodiments, the instructions further cause the processor to receive manual service creation of the one or more network service VMs.

The foregoing outlines features of several embodiments so that those skilled in the art better understand the aspects of the present disclosure. Those skilled in the art appreciate that they readily use the present disclosure as a basis for designing or modifying other processes and structures for carrying out the same purposes and/or achieving the same advantages of the embodiments introduced herein. Those skilled in the art also realize that such equivalent constructions do not depart from the spirit and scope of the present disclosure, and that they make various changes, substitutions, and alterations herein without departing from the spirit and scope of the present disclosure.

What is claimed is:

1. A computer-implemented method, comprising:
receiving an application manifest file from an application uploaded to a network;
mapping application manifest file parameters from the application manifest file to an IP manager;
determining services available based on the mapped application manifest file parameters; and
deploying the application on one or more virtual machines (VMs) or one or more containers.

2. The computer-implemented method of claim 1, wherein the mapping the application manifest file parameters from the application manifest file to the IP manager further comprises:
determining each static parameter of the application manifest file of the application set for a lifetime of the application.

3. The computer-implemented method of claim 1, wherein the mapping the application manifest file parameters from the application manifest file to the IP manager further comprises:
determining each variable parameter of the application manifest file of the application that is configured to be modified.

4. The computer-implemented method of claim 3, further comprising:
responsive to determining that an application manifest file parameter is variable, determining a value for the application manifest file parameter from the application manifest file.

5. The computer-implemented method of claim 1, further comprising:
creating a network function descriptor (NFD) that determines instantiation parameters and operational behaviors of virtual network functions (VNFs) to execute the application.

6. The computer-implemented method of claim 5, further comprising:
causing a graphical user interface (GUI) to be output by a display, the GUI comprising:
a network service descriptor (NSD) template that includes one or more user input fields configured to receive a user input to modify the instantiation parameters and operational behaviors to create a network service to provide the application through a VNF.

7. The computer-implemented method of claim 6, further comprising:
creating one or more network service virtual machines (VMs) for executing the application.

8. The computer-implemented method of claim 7, wherein the creating the one or more network service VMs, further comprises:
deploying a plurality of network service VMs automatically.

9. The computer-implemented method of claim 7, wherein the creating the one or more network service VMs, further comprises:
receiving manual service creation of the one or more network service VMs.

10. The computer-implemented method of claim 8, further comprising:
deploying one or more VNFs to the network via the GUI through an orchestrator.

11. An apparatus, comprising:
a processor; and
a memory having instructions stored thereon that, when executed by the processor, cause the apparatus to:
receive an application manifest file from an application;
map application manifest file parameters from the application manifest file to an IP manager;
determine services available based on the mapped application manifest file parameters; and
deploy the application.

12. The apparatus of claim 11, wherein the instructions further cause the apparatus to:
determine each static file parameter of the application manifest file of the application set for a lifetime of the application.

13. The apparatus of claim 11, wherein the instructions further cause the apparatus to:
determine each variable file parameter of the application manifest file of the application that is configured to be modified.

14. The apparatus of claim 13, wherein the instructions further cause the apparatus to:
responsive to determining that an application manifest file parameter is variable, determine a value for the application manifest file parameter from the application manifest file.

15. The apparatus of claim 11, wherein the instructions further cause the apparatus to:
create a network function descriptor (NFD) that determines instantiation parameters and operational behaviors of virtual network functions (VNFs) to execute the application.

16. The apparatus of claim 15, further comprising:
a graphical user interface (GUI) to be output by a display, the GUI comprising:
a network service descriptor (NSD) template that includes one or more user input fields configured to receive a user input to modify the instantiation parameters and operational behaviors to create a network service to provide the application through a VNF.

17. A non-transitory computer readable medium having instructions stored thereon that, when executed by a processor, cause an apparatus to:
receive an application manifest file from an application at a network;
map application manifest file parameters from the application manifest file to an IP manager;
determine services available based on the mapped application manifest file parameters; and
deploy the application.

18. The non-transitory computer readable medium of claim 17, wherein the instructions further cause the processor to:
create one or more network service virtual machines (VMs) for executing the application.

19. The non-transitory computer readable medium of claim 18, wherein the instructions further cause the processor to:
deploy a plurality of network service VMs automatically.

20. The non-transitory computer readable medium of claim 19, wherein the instructions further cause the processor to:
receive manual service creation of the one or more network service VMs.
